(19) United States
(12) Patent Application Publication
(10) Pub. No.: US 2024/0422410 A1
(43) Pub. Date: Dec. 19, 2024

(54) LIGHT SOURCE UNIT AND VEHICLE

(71) Applicant: Panasonic Intellectual Property Management Co., Ltd., Osaka (JP)

(72) Inventors: Mitsuhiro UCHIDA, Osaka (JP); Yoshihiko KANAYAMA, Hyogo (JP); Toshinao AKIE, Hyogo (JP); Takeshi WATANABE, Osaka (JP); Ryohei KIMOTO, Hyogo (JP); Toshiaki MURAI, Osaka (JP)

(73) Assignee: Panasonic Intellectual Property Management Co., Ltd., Osaka (JP)

(21) Appl. No.: 18/704,287

(22) PCT Filed: Oct. 24, 2022
(86) PCT No.: PCT/JP2022/039505

§ 371 Date: Apr. 24, 2024

(30) Foreign Application Priority Data
Nov. 11, 2021 (JP) 2021-183898

(51) Int. Cl. H04N 23/21; H04N 23/56

(52) U.S. Cl. CPC H04N 23/21; H04N 23/56

(57) ABSTRACT

A light source unit includes a light-emitting device to be attached to a vehicle together with an image capturing device, and the light-emitting device emits near infrared light to a road in a lateral area of vehicle and a road in at least one of the front area or the rear area of the vehicle.

### TECHNICAL FIELD

The present invention relates to a light source unit and a vehicle.

### BACKGROUND ART

There are light-emitting devices that are disposed on a vehicle and emit light to the road around the vehicle (see Patent Literature (PTL) 1, for example).

As an example of such light-emitting devices, PTL 1 discloses an illuminating device that is attached to a side mirror and illuminates the feet of passengers outside the vehicle.

### CITATION LIST

### Patent Literature

[PTL 1] Japanese Unexamined Patent Application Publication No. 2015-71386

### SUMMARY OF INVENTION

### Technical Problem

For example, the side mirror may be provided with not only a light-emitting device that emits light but also an image capturing device that captures an image of the road. Such an image capturing device captures an image of the road by detecting light emitted from the light-emitting device and then reflected off the road, an obstacle or the like. Therefore, the light-emitting device is required to properly emit light to the road so that the image capturing device attached to the vehicle can capture a precise image of the road.

The present invention provides a light source unit and the like that allows an image capturing device attached to a vehicle to capture a precise image of a road.

### Solution to Problem

A light source unit according to an aspect of the present invention includes a light-emitting device to be attached to a vehicle together with an image capturing device, and the light-emitting device emits near infrared light to a road in a lateral area of the vehicle and a road in at least one of the front area or the rear area of the vehicle.

A vehicle according to an aspect of the present invention includes the light source unit described above.

### Advantageous Effects of Invention

With the light source unit according to an aspect of the present invention and the like, the image capturing device attached to the vehicle can capture a precise image of a road.

### BRIEF DESCRIPTION OF DRAWINGS

FIG. 1 is a front view of a vehicle according to an embodiment.

FIG. 2 is a block diagram illustrating a configuration of a light source unit according to the embodiment.

FIG. 3 is a rear view of the vehicle according to the embodiment.

FIG. 4 is a top view of the vehicle according to the embodiment.

FIG. 5 is a top view schematically illustrating irradiated areas irradiated with light from a side marker lamp and a backup lamp provided on the vehicle according to the embodiment.

FIG. 6 is a top view schematically illustrating irradiated areas irradiated with light emitted from light emitters according to the embodiment.

FIG. 7 is a cross-sectional view of a light emitter according to the embodiment.

FIG. 8 is a cross-sectional view of a light emitter according to a variation.

FIG. 9 is a bottom view of a light-shielding component included in the light emitter according to the variation.

### DESCRIPTION OF EMBODIMENTS

In the following, embodiments of the present invention will be described with reference to the drawings. Any embodiment described below shows a comprehensive or specific example. Numerical values, shapes, materials, components, arrangements and ways of connection of components, and the like shown in the embodiments described below are just examples and are not intended to limit the present invention. Of the components in the embodiments described below, components that are not described in the independent claims, which indicate the top-level concepts, are described as optional components.

The drawings are schematic diagrams and are not necessarily drawn to scale. Therefore, for example, the scale or the like is not necessarily consistent in each drawing. The drawings are schematic diagrams that involve enhancements, omissions, or proportion adjustments as required for illustrating the present invention, and do not necessarily illustrate actual shapes, positional relationships, or proportions. In the drawings, substantially the same components are denoted by the same reference numerals, and redundant descriptions may be omitted or simplified.

In the embodiment described below, the Z-axis direction is the vertical direction, for example, the positive side along the Z axis may be referred to as upper, above, or the like, and the negative side along the Z axis may be referred to as lower, below, or the like. The Y-axis direction and the X-axis direction are perpendicular to each other on a plane (horizontal plane) perpendicular to the Z axis. The Y-axis direction may be referred to as a side of a vehicle. The positive direction along the X axis may be referred to as a traveling direction (front) of a vehicle, and the negative direction along the X axis may be referred to as an opposite direction (rear) to the traveling direction of the vehicle.

In the embodiment described below, an expression indicating a direction, such as a “horizontal direction”, may be used. In such a case, the “horizontal direction” means not only the perfect horizontal direction but also a direction having a margin of error of the order of several percent, such as 5%, which occurs during manufacture or arrangement.

### Embodiment

### Configuration

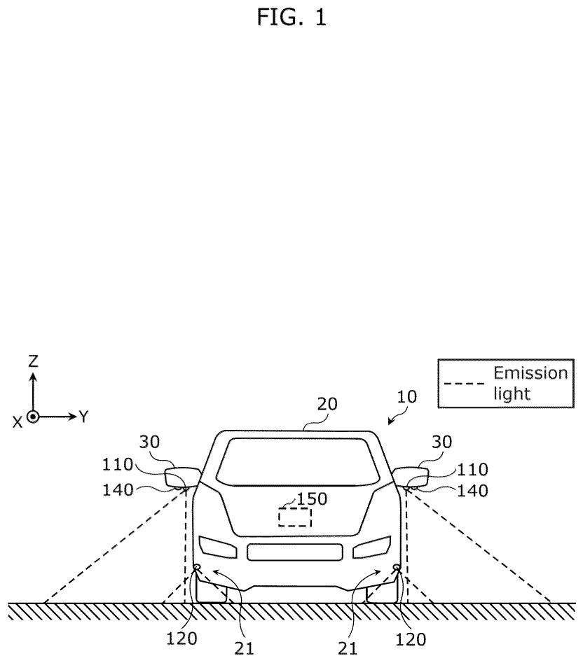

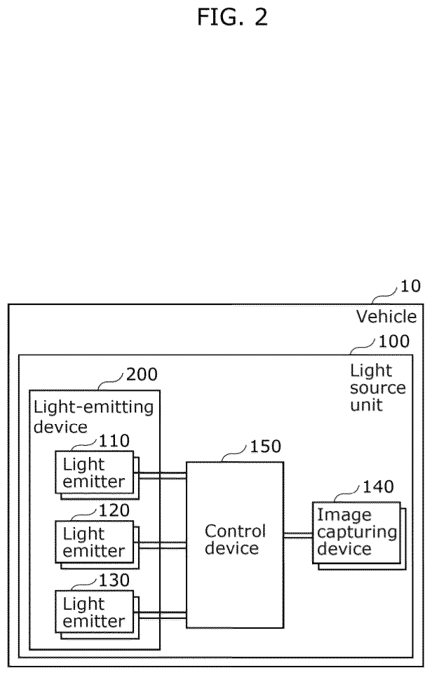

FIG. 1 is a front view of vehicle 10 according to an embodiment. FIG. 2 is a block diagram illustrating a configuration of light source unit 100 according to the embodiment. In FIG. 1, light (emission light) emitted by light emitters 110 and 120 is indicated by a dashed line.

Vehicle 10 is a mobile body, such as an automobile or motorcycle, provided with light source unit 100. In this embodiment, vehicle 10 is an automobile.

Vehicle 10 includes vehicle body 20, side mirror 30, and light source unit 100.

Vehicle body 20 is a vehicle main body in which a driver rides for driving the vehicle, and has side mirror 30 attached to a side part thereof. With this vehicle body 20, side mirrors 30 are supported on both side parts of vehicle body 20.

Side mirror 30 is a mirror attached to a side part of vehicle body 20. In this embodiment, light emitter 110 and image capturing device 140 are attached to side mirror 30.

In this embodiment, side mirrors 30 disposed on both side parts (both sides in the Y-axis direction) of vehicle body 20 of vehicle 10 are each provided with light emitter 110 and image capturing device 140. However, light emitter 110 and image capturing device 140 may be provided on only one side mirror 30.

Light source unit 100 is an optical unit that emits light to a road and detects the emitted light reflected off the road. That is, light source unit 100 captures an image of a road by emitting light to the road.

As illustrated in FIG. 2, light source unit 100 includes light-emitting device 200, image capturing device 140, and control device 150.

Light-emitting device 200 and image capturing device 140 of light source unit 100 are disposed on an outer surface of vehicle 10, for example. Specifically, light-emitting device 200 is attached to vehicle 10 at a position where the road around vehicle 10 can be irradiated when light-emitting device 200 emits light downward.

Note that the outer surface includes not only outer surface of vehicle body 20 of vehicle 10 including outer surfaces in the horizontal direction, such as front, rear, left, and right surfaces, but also outer surfaces located laterally with respect to vehicle body 20, such as a side surface of side mirror 30, the bottom surface of side mirror 30, or the outer side surface of a door of vehicle 10. That vehicle 10 includes light-emitting device 200 and image capturing device 140 on the outer surface means not only a case where light-emitting device 200 and image capturing device 140 are disposed on the outer surface but also a case where light-emitting device 200 and image capturing device 140 are disposed near the outer surface in vehicle 10.

Light-emitting device 200 is a light source part that is attached to vehicle 10 together with image capturing device 140 and emits light to the road. In this embodiment, light-emitting device 200 emits near infrared light.

The near infrared light emitted by light-emitting device 200 is light in a wavelength range of at least 800 nm. The wavelength range of the near infrared light emitted by light-emitting device 200 may be from 910 nm to 970 nm. In sunlight, light of a wavelength of about 940 nm has a lower intensity than light of other wavelengths. Therefore, if the wavelength range of the near infrared light emitted by light-emitting device 200 is 940±30 nm, image capturing device 140 can capture a precise image of the road even if the detection wavelength of light of image capturing device 140 is on the order of 940 nm.

Light-emitting device 200 includes a plurality of light emitters. In this embodiment, light-emitting device 200 includes two light emitters 110, two light emitters 120, and two light emitters 130.

Light emitter 110 is a light source part attached to side mirror 30. In this embodiment, light emitter 110 is attached to a lower part of side mirror 30. For example, light emitter 110 is attached to vehicle body 20 in such a manner that the optical axis of the emitted light is oblique to the vertical direction (specifically, the normal direction to the road on which the vehicle 10 rests). Specifically, light emitter 110 is attached to side mirror 30 so as to emit light in the direction opposite to vehicle body 20.

Light emitter 110 is an example of a first light-emitter.

Light emitter 120 is a light source part attached to a front part of vehicle body 20. Specifically, as illustrated in FIG. 1, light emitter 120 is attached to overhang surface 21 of the front part of vehicle body 20. For example, light emitter 120 is attached to vehicle body 20 in such a manner that the optical axis of the emitted light is oblique to the vertical direction. Specifically, light emitter 120 is attached to vehicle body 20 so as to emit light in the direction opposite to vehicle body 20.

Light emitter 130 is a light source part attached to a rear part of vehicle body 20.

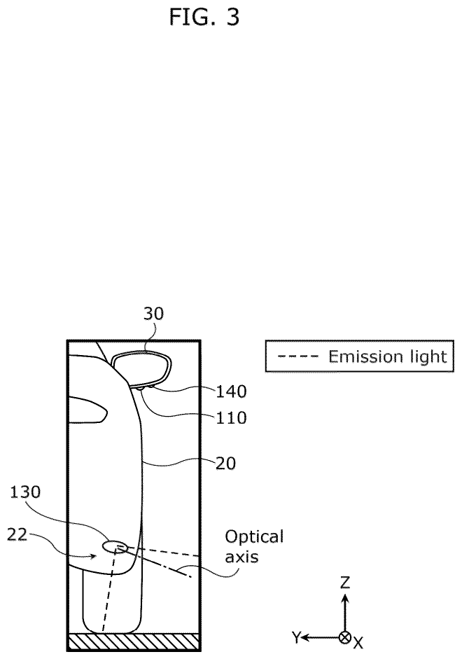

FIG. 3 is a rear view of vehicle 10 according to the embodiment. In FIG. 3, light (emission light) emitted by light emitter 130 is indicated by a dashed line.

As illustrated in FIG. 3, for example, light emitter 130 is attached to vehicle body 20 in such a manner that the optical axis (axis indicated by an alternate long and short dash line in FIG. 3) of the emitted light is oblique to the vertical direction. Specifically, light emitter 130 is attached to vehicle body 20 so as to emit light in the direction opposite to vehicle body 20.

For example, light emitter 130 is attached to overhang surface 22 of vehicle body 20.

Overhang surfaces 21 and 22 are surfaces of a lower part of vehicle body 20 that are oblique to the vertical direction. For example, light emitter 130 is disposed on vehicle body 20 in such a manner that light emitter 130 emits no light at least above the horizontal direction.

Similarly, for example, light emitter 110 may be disposed on side mirror 30 in such a manner that light emitter 110 emits no light at least above the horizontal direction. Similarly, for example, light emitter 120 may be disposed on vehicle body 20 in such a manner that light emitter 120 emits no light at least above the horizontal direction.

Light emitters 120 and 130 are examples of a second light emitter. For example, the second light emitters are attached overhang surfaces 21 and 22 of vehicle body 20. For example, the second light emitters are attached to vehicle body 20 below image capturing device 140 in the vertical direction. The first light-emitters (light emitters 110 in this embodiment) may also be attached to vehicle body 20 below image capturing device 140 in the vertical direction.

In this embodiment, light-emitting device 200 includes light emitters 120 and light emitters 130 and therefore emits near infrared light to roads in both a front area and a rear area of vehicle 10. Light-emitting device 200 has only to emit near infrared light to a road in at least one of the front area and the rear area of vehicle 10. That is, light-emitting device 200 emits light to a road in a lateral area of vehicle 10 and a road in at least one of the front area and the rear area of vehicle 10. For example, light-emitting device 200 may have at least one of light emitters 120 and light emitters 130. More specifically, for example, light-emitting device 200 has the first light-emitters (light emitters 110 in this embodiment) attached to side mirrors 30 of vehicle 10 and the second light emitters (at least one of light emitters 120 and light emitters 130, for example) attached to at least one of the front part and the rear part of vehicle body 20 of vehicle 10. The first light-emitter emits light to the road in the lateral area of vehicle 10, for example. The second light emitter emits near infrared light to the road in at least one of the front area and the rear area of vehicle 10, for example. For example, when the second light emitter is attached to the front part of vehicle body 20, the second light emitter serves as light emitter 120 and emits light to the road in the front area of vehicle 10. Alternatively, when the second light emitter attached to the rear part of vehicle body 20, the second light emitter serves as light emitter 130 and emits light to the road in the rear area of vehicle 10.

Image capturing device 140 is a camera that captures an image of a road. Specifically, image capturing device 140 detects light emitted by light-emitting device 200 and reflected off the road. Specifically, image capturing device 140 is attached to side mirror 30 in such a manner that image capturing device 140 can detect light emitted by light-emitting device 200 and reflected off the road. Image capturing device 140 detects light reflected off the road around vehicle 10 and thereby generates an image of the road. As described above, for example, light-emitting device 200 is a near infrared light source that emits near infrared light, and image capturing device 140 detects near infrared light emitted by light-emitting device 200, or more specifically, near infrared light emitted by light-emitting device 200 and reflected off the road.

Image capturing device 140 has an imaging element, such as a charge coupled device (CCD) image sensor or a complementary metal oxide semiconductor (CMOS) image sensor.

In this embodiment, vehicle body 20, light emitter 110, and image capturing device 140 are arranged in this order. Vehicle body 20, image capturing device 140, and light emitter 110 may be arranged in this order.

Image capturing device 140 may be located, relative to light-emitting device 200, on the side opposite to the direction in which light-emitting device 200 emits light (the downward direction or the negative direction along the Z-axis in this embodiment). That is, image capturing device 140 may be located above light-emitting device 200. In this embodiment, image capturing device 140 is located above light emitters 110, 120, and 130.

Therefore, light emitted from light-emitting device 200 is prevented from being directly incident on image capturing device 140 without being reflected off the road.

Light source unit 100 may include a light shield that is located between image capturing device 140 and light emitter 110 and shields light emitted by light emitter 110. The light shield has only to have a function of shielding the light and may reflect or absorb the light.

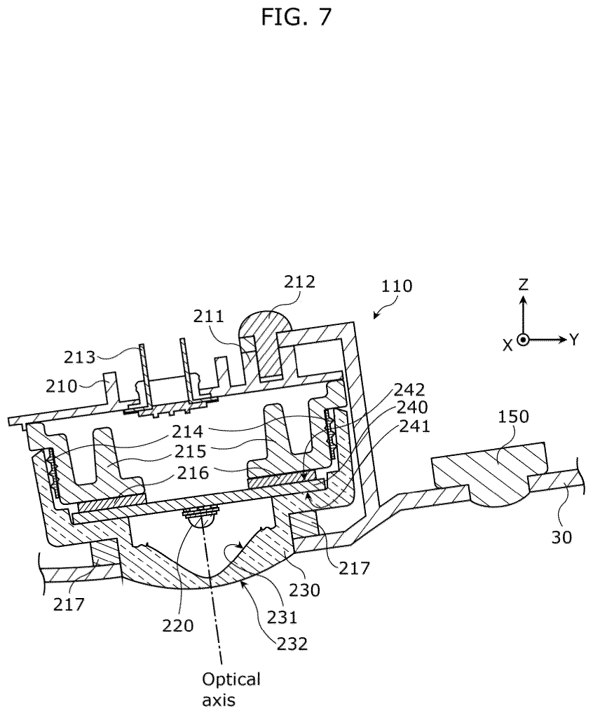

Control device 150 is a processor for controlling light-emitting device 200 and image capturing device 140. For example, control device 150 causes the timing of emitting light by light-emitting device 200 to be the same as the timing of capturing an image by image capturing device 140. That is, control device 150 controls light-emitting device 200 and image capturing device 140 in synchronization so that image capturing device 140 can properly detect the light emitted by light-emitting device 200 and reflected off the road. For example, control device 150 performs pulse-width-modulation (PWM) control on light-emitting device 200 (PWM lighting) in synchronization with image capturing device 140. In this way, compared with a case where light-emitting device 200 (more specifically, LEDs or other light-emitting elements of light source 220 (see FIG. 7) described later) is driven with a constant current, the heat generation can be reduced, and If (forward current) can be increased.

Control device 150 is implemented by an interface to which control lines or the like for controlling light-emitting device 200 and image capturing device 140 are connected, a nonvolatile memory storing a program, a volatile memory that is a temporary storage area for executing a program, and a processor for executing a program, for example.

Next, a specific example of irradiated areas irradiated by light emitted by light-emitting device 200 will be described.

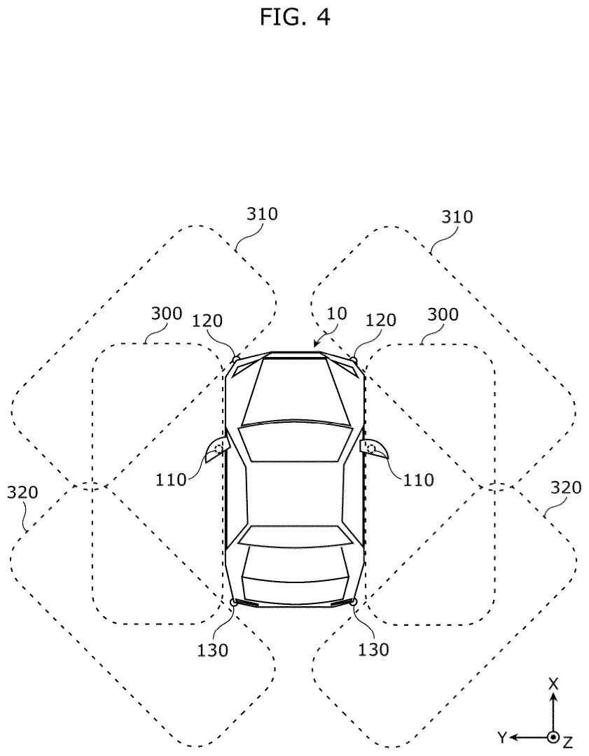

FIG. 4 is a top view of vehicle 10 according to the embodiment. Specifically, FIG. 4 is a diagram for describing areas irradiated by light emitted to the road by light emitters 110, 120, and 130.

Light emitters 110, 120, and 130 each emit light (more specifically, near infrared light) to the road around vehicle 10. For example, areas of the road inside irradiated areas 200, 310, and 320 indicated by dashed lines in FIG. 4 are irradiated with light emitted by light-emitting device 200 (more specifically, light emitters 110, 120, and 130).

Light emitter 110 emits light to the road in a lateral area of vehicle 10. In this embodiment, light emitter 110 illuminates irradiated area 300 of the road with light.

Light emitter 120 emits light to the road in a front area of vehicle 10. In this embodiment, light emitter 120 illuminates irradiated area 310 of the road with light.

Light emitter 130 emits light to the road in a rear area of vehicle 10. In this embodiment, light emitter 130 illuminates irradiated area 320 of the road with light.

Light emitters 110, 120, and 130 irradiate the road in the lateral area of vehicle 10 with light.

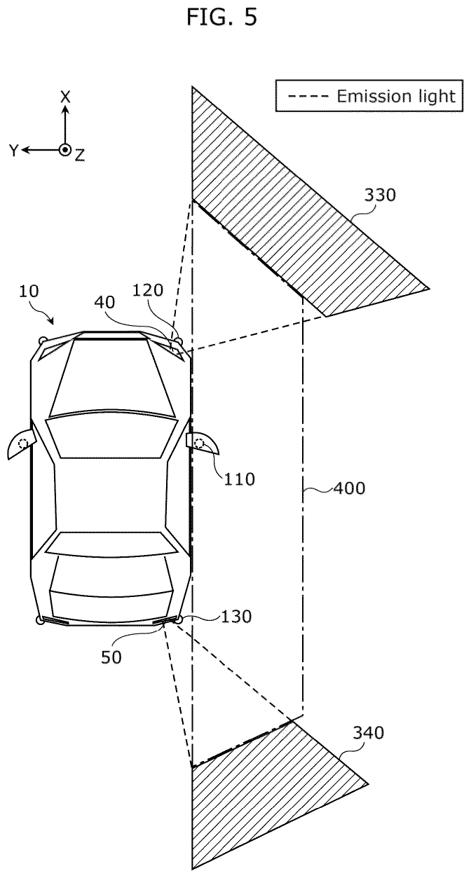

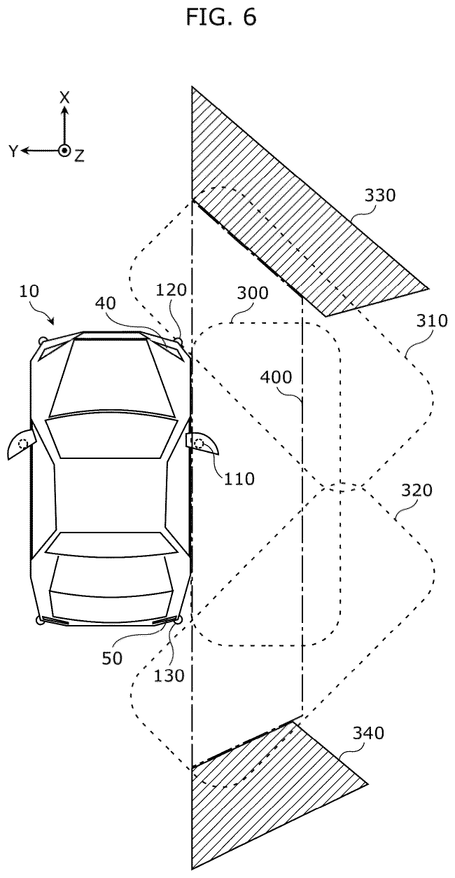

FIG. 5 is a top view schematically illustrating irradiated areas irradiated with light from side marker lamp 40 and backup lamp 50 of vehicle 10 according to the embodiment. FIG. 6 is a top view schematically illustrating irradiated areas irradiated with light emitted by light emitters 110, 120, and 130 according to the embodiment.

Specifically, FIG. 5 illustrates a state where light emitters 110, 120, and 130 emit no light, and side marker lamp 40 and backup lamp 50 emit light. FIG. 6 illustrates a state where light emitters 110, 120, and 130 emit light, and side marker lamp 40 and backup lamp 50 emit light.

In FIG. 5, irradiated area 330 irradiated with light from side marker lamp 40 and irradiated area 340 irradiated with light from backup lamp 50 are hatched.

FIGS. 5 and 6 schematically illustrate only the light-irradiated areas on the negative side of vehicle 10 along the Y axis.

In FIG. 5, light (emission light) emitted by light emitters 120 and 130 is indicated by a dashed line.

As illustrated in FIG. 5, side marker lamp 40 and backup lamp 50 do not emit light to the road in the lateral area near vehicle 10.

In the example illustrated in FIG. 5, non-irradiated area 400 indicated by an alternate long and short dash line is not irradiated with light emitted by side marker lamp 40 and backup lamp 50. Therefore, in the nighttime or in bad weather, for example, the road in the lateral area near vehicle 10 is dark because there is less ambient light such as sunlight and the area is not irradiated with light by side marker lamp 40, backup lamp 50 and the like. Therefore, in a dark environment, such as in the nighttime, image capturing device 140 does not capture a precise image of the road in the lateral area of vehicle 10. That is, the road is not clearly captured in the image generated by image capturing device 140.

In view of this, light-emitting device 200 of vehicle 10 emits light to the road in the lateral area of vehicle 10. Thus, even in a dark environment, such as in the nighttime, the light emitted by light-emitting device 200 allows image capturing device 140 to capture a precise image of the road in the lateral area of vehicle 10.

The inventors of this application found that the front area and the rear area of vehicle 10 include a part near vehicle 10 that is not irradiated with light from conventional illuminating devices for vehicle 10 that illuminate the surroundings of vehicle 10, such as side marker lamp 40 and backup lamp 50, and a headlamp and a fog lamp. In view of this, light-emitting device 200 emits light to the road in the lateral area of vehicle 10 and the road in the front area and the rear area of vehicle 10. Specifically, as illustrated in FIG. 6, light emitters 110, 120, and 130 emit light so that non-irradiated area 400 is irradiated with light. In this way, areas that are not irradiated with light from illuminating devices of vehicle 10, such as side marker lamp 40 and backup lamp 50, can be irradiated with light from light-emitting device 200 of vehicle 10.

Light spots (that is, irradiated areas 300, 310, and 320) of light emitters 110, 120, and 130 may partially overlap with each other. For example, the light spot of light emitter 110 may partially overlap with the light spot of light emitter 120. For example, the light spot of light emitter 110 may partially overlap with the light spot of light emitter 130.

The light spots of light-emitting device 200 may partially overlap with a light spot of the headlamp, side marker lamp 40, backup lamp 50, a fog lamp and the like of vehicle 10. In this way, the area that is not irradiated with light-emitting device 200 can be reduced. That is, the road around vehicle 10 can be uniformly illuminated by light-emitting device 200 and the illuminating devices of vehicle 10, such as side marker lamp 40.

The distance from vehicle 10 reached by the light emitted by light-emitting device 200 is arbitrary. For example, light-emitting device 200 emits light to the road in a range of 1.5 m from vehicle 10 in the lateral direction. In this case, light-emitting device 200 can irradiate with light a marking on the road near vehicle 10, such as a white line indicating a driving lane or a parking space. In this case, if image capturing device 140 displays the captured image of the road on a display or the like disposed in vehicle 10, for example, the driver can easily locate the white line by seeing the image displayed on the display.

In recent years, the development of autonomous driving vehicles is in progress. Some of such vehicles may determine the travel route by detecting the location of the white line with a camera. When vehicle 10 is an autonomous driving vehicle, vehicle 10 can be autonomously driven with high precision since light source unit 100 can capture a precise image of the road.

For example, light-emitting device 200 may emit light to the road in a range of 2.0 m from vehicle 10 in the lateral direction. In this case, when vehicle 10 is an autonomous driving vehicle, for example, light source unit 100 can properly detect markers or the like provided on the road at intervals of 2 m, for example, to detect the location of vehicle 10.

Alternatively, for example, light-emitting device 200 may emit light to the road in a range of 4.35 m from vehicle in the lateral direction. In this case, when vehicle 10 is traveling on an expressway, for example, light-emitting device 200 can illuminate with light not only the white line of the driving lane in which the vehicle is traveling but also the white line of an adjacent driving lane.

Light-emitting device 200 emits light that illuminates the road at an illuminance of at least 1.0×10⁻³ W/m². This allows image capturing device 140 to capture a precise image of the white line of the driving lane.

The illuminance of at least 1.0×10⁻³ W/m² has only to be achieved on at least one of the road in the lateral area of vehicle 10 and at least one of the road in the front area of vehicle 10 and the road in the rear area of vehicle 10. For example, the illuminance of at least 1.0×10⁻³ W/m² may be achieved on the road in the lateral area of vehicle 10, the road in the front area of vehicle 10, and the road in the rear area of vehicle 10. Specifically, the illuminance on entire non-irradiated area 400 may be at least 1.0×10⁻³ W/m². For example, light-emitting device 200 may emit light that continuously illuminates the lateral area of vehicle 10 between irradiated area 330 irradiated with light by side marker lamp 40 and irradiated area 340 irradiated with light by backup lamp 50 at an illuminance of at least 1.0×10⁻³ W/m².

Light-emitting device 200 emits light at an illuminance of at most 0.5 W/m², for example. In this case, the occurrence of a halation in image capturing device 140 caused by excessively intense light emitted from light-emitting device 200 can be prevented.

Next, a specific configuration of light emitter 110 of light-emitting device 200 will be described.

FIG. 7 is a cross-sectional view of light emitter 110 according to the embodiment. FIG. 7 is a diagram illustrating a cross section of light emitter 110 and image capturing device 140 disposed on side mirror 30 located on the right side when vehicle 10 is viewed from the front.

Light emitter 110 includes lid 210, terminal unit 213, packing 214, heat sink 215, heat radiation sheet 216, cushioning material 217, light source 220, lens 230, and substrate 240.

Lid 210 is a lid body for attaching light emitter 110 to side mirror 30. Attachment 211 is formed on lid 210, and a threaded hole into which screw 212 is to be attached is formed in attachment 211, for example. Light emitter 110 is attached to side mirror 30 by screwing screw 212 to attachment 211. The material of lid 210 is not particularly limited, and a resin material, such as polybutyleneterephtalate (PBT) or polycarbonate, or a metal material is used, for example.

Terminal unit 213 is a terminal for supplying electric power supplied from an external power supply or the like (not shown) to light source 220. Terminal unit 213 and light source 220 are electrically connected to each other by metal wiring or the like (not shown).

Packing 214 is a cushioning material located between lens 230 and heat sink 215. Packing 214 is made of a resin material having elasticity, such as rubber.

Heat sink 215 is disposed on the back surface 242 side of substrate 240, which is a surface opposite to principal surface 241 on which light source 220 is disposed. Heat sink 215 is a heat radiation member for radiating heat generated by light source 220. In this embodiment, heat sink 215 is supported on lid 210. Heat sink 215 is made of an aluminum metal, stainless steel or the like that has high thermal conductivity, for example. Substrate 240 is mounted on heat sink 215 with heat radiation sheet 216 therebetween.

Heat radiation sheet 216 is a sheet-shaped member for facilitating radiation of heat generated by light source 220 from substrate 240 to heat sink 215. The material used for heat radiation sheet 216 is not particularly limited, and a resin material or the like is used, for example. Heat radiation sheet 216 may have electrical insulating properties.

Cushioning material 217 is a member disposed between side mirror 30 and lens 230. Cushioning material 217 is a member having elasticity, such as a sponge.

Light source 220 is a light source that emits light. Light source 220 emits near infrared light, for example. Light source 220 has a solid-state semiconductor light source, such as a light emitting diode (LED), and a lens that covers the solid-state semiconductor light source.

Lens 230 is an optical member on which light emitted by light source 220 is incident and from which the incident light exits. Specifically, lens 230 is a transmitter lens that is disposed to cover a lower part of light source 220, receives light emitted by light source 220, and emits the received light to the road while controlling the light distribution. In this embodiment, lens 230 has the shape of a cup that projects downward and has an open top. Light source 220 and substrate 240 are housed in lens 230. The top of lens 230 is closed with lid 210. Lens 230 (more specifically, the base material of lens 230) is made of a glass material having a transparency or a transparent resin material such as acrylic or polycarbonate, for example.

Although the shape of lens 230 is a convex shape projecting downward in this embodiment, the shape is not particularly limited and may be a planar shape, for example.

The radius of curvature of lens 230 (for example, the radius of curvature of inner surface 231 of lens 230 or the radius of curvature of outer surface 232 of lens 230) may be arbitrarily set. For example, the radius of curvature of outer surface 232 of lens 230 may be at most 10 m.

Substrate 240 is a substrate on which light source 220 is mounted. Substrate 240 is disposed in such a manner that principal surface 241 on which light source 220 is mounted is in contact with lens 230. The material of substrate 240 is not particularly limited, and a metal substrate, a ceramic substrate, or a resin substrate is used, for example. Substrate 240 may be a flexible substrate or a rigid substrate.

Light emitter 110 may be attached to side mirror 30 in such a manner that the optical axis of the light emitted by light source 220 is parallel to the vertical direction or the optical axis of the light emitted by light source 220 intersects with the vertical direction as illustrated by an alternate long and short dash line in FIG. 7. Light emitter 110 may be disposed in such a manner that light source 220 emits light in the direction away from vehicle body 20, for example. In this example, light emitter 110 is disposed on side mirror 30 in such a manner that entire light emitter 110 is inclined so that the optical axis of the light emitted by light source 220 intersects with the vertical direction.

Light emitters 120 and 130 may have basically the same configuration as light emitter 110 except for the location thereof and the configuration of lid 210 for attachment to vehicle 10, for example. Light emitters 120 and 130 include terminal unit 213, packing 214, heat sink 215, heat radiation sheet 216, cushioning material 217, light source 220, lens 230, and substrate 240, for example.

### [Variation]

Next, a variation of the embodiment will be described. In the description of the variation of the embodiment, differences from the embodiment will be mainly described. Components that are substantially the same as the components described in the embodiment will be denoted by the same reference numerals, and descriptions thereof may be partially simplified or omitted.

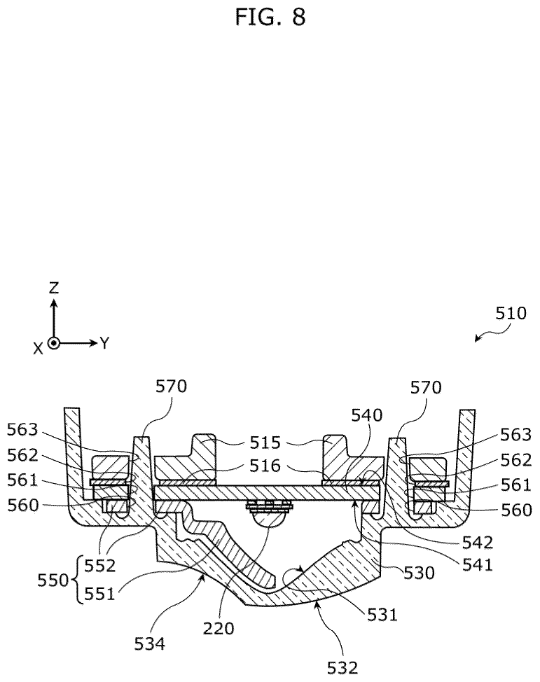

FIG. 8 is a cross-sectional view of light emitter 510 according to the variation.

The cross-sectional view of FIG. 8 illustrates a cross section corresponding to that in FIG. 7. In FIG. 8, illustration of some components of image capturing device 140 and light emitter 510, such as lid 210, is omitted. For example, in addition to the components illustrated in FIG. 8, light emitter 510 may further include lid 210, terminal unit 213, packing 214, cushioning material 217 and the like, as with light emitter 110 illustrated in FIG. 7.

Light emitter 510 includes lid 210, terminal unit 213, packing 214, heat sink 515, heat radiation sheet 516, cushioning material 217, light source 220, lens 530, substrate 540, and light-shielding component 550.

Light emitter 510 is a light source part that emits light (more specifically, near infrared light) to the road (downward). For example, light emitter 510 is supported on side mirror 30 side by side with image capturing device 140, and emits light detected by image capturing device 140.

Heat sink 515 is disposed on the back surface 542 side of substrate 540, which is a surface opposite to principal surface (mounting surface) 541 on which light source 220 is disposed. Heat sink 515 is a heat radiation member for radiating heat generated by light source 220. Heat sink 515 is made of an aluminum metal, stainless steel or the like that has high thermal conductivity, for example. Substrate 540 is mounted on heat sink 515 with heat radiation sheet 516 therebetween.

Heat radiation sheet 516 is a sheet-shaped member for facilitating radiation of heat generated by light source 220 from substrate 540 to heat sink 515. The material used for heat radiation sheet 516 is not particularly limited, and a resin material or the like is used, for example. Heat radiation sheet 516 may have electrical insulating properties.

Substrate 540 is a substrate on which light source 220 is mounted. Substrate 540 is disposed in such a manner that principal surface 541 on which light source 220 is mounted is in contact with lens 530. The material of substrate 540 is not particularly limited, and a metal substrate, a ceramic substrate, or a resin substrate is used, for example. Substrate 540 may be a flexible substrate or a rigid substrate.

Lens 530 is an optical member on which light emitted by light source 220 is incident and from which the incident light exits. Specifically, lens 530 is a transmitter lens that is disposed to cover a lower part of light source 220, receives light emitted by light source 220, and emits the received light to the road while controlling the light distribution. Heat sink 515, heat radiation sheet 516, light source 220, and substrate 540 are housed in lens 530.

Lens 530 (more specifically, the base material of lens 530) is made of a glass material having a transparency or a transparent resin material such as acrylic or polycarbonate, for example.

Although the shape of lens 530 is a convex shape projecting downward in this embodiment, the shape is not particularly limited and may be a planar shape, for example.

Lens 530 has recessed portion 534 located on the vehicle 10 of outer surface 532 of lens 530 when viewed from light source 220, when lens 530 is attached to vehicle 10, for example, where recessed portion 534 is recessed toward the light source 220, and outer surface 532 is opposite to inner surface 531 located closer to light source 220. Recessed portion 534 may smoothly connect to the surface of a part of lens 530 other than recessed portion 534.

Light-shielding component 550 is a member that is disposed between light source 220 and lens 530 and absorbs, reflects, or diffuses at least part of light that is emitted from light source 220 and travels toward vehicle 10. For example, light-shielding component 550 is highly reflective to light emitted from light source 220.

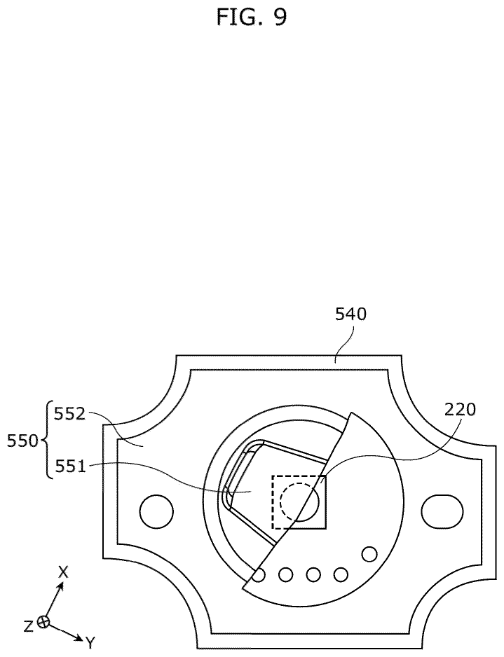

FIG. 9 is a bottom view of light-shielding component 550 of light emitter 510 according to the variation. In FIG. 9, light source 220 of light emitter 510, substrate 540, and light-shielding component 550 are illustrated, and illustration of the other components is omitted.

Light-shielding component 550 includes a light shield 551 and flat plate 552, for example.

Light shield 551 is a light-shielding part that is located between lens 530 and light source 220 and absorbs, reflects, or diffuses at least part of light that is emitted from light source 220 and travels toward a part located toward vehicle 10.

For example, light shield 551 is arranged to continuously cover from a point on a negative side of light source 220 along the Y axis to extend beyond a point directly below light source 220. In this way, when attached to vehicle 10, for example, light-shielding component 550 is disposed from the vehicle 10 side of light source 220 to continuously extend beyond a point directly below light source 220 when viewed from light source 220.

The expression “beyond a point directly below light source 220” means beyond the center of light source 220 on the opposite side to vehicle 10 when light source 220 is viewed from below, for example. When light source 220 is viewed from below, light shield 551 may cover more than a half of the area of light source 220 or may completely cover light source 220.

Light shield 551 has a shape curved along inner surface 531 of lens 530 (a half cup shape, for example), for example.

Although light shield 551 may be in contact with light source 220, light shield 551 is preferably not in contact with light source 220. If light-shielding component 550 is not in contact with light source 220, heat generated by light source 220 can be prevented from being transferred to light-shielding component 550 and accumulated in the space defined by lens 530 and substrate 540.

The distance between light shield 551 and light source 220 is not particularly limited and can be arbitrarily set. The distance between light shield 551 and light source 220 is at least 1 mm, for example.

For example, in plan view (bottom view) of light-shielding component 550, an opening portion is formed in a central portion of light-shielding component 550. In plan view, light source 220 is located at a position corresponding to the opening portion. Light emitted by light source 220 passes through the opening portion and lens 530 and exits to the outside of light emitter 610. Light shield 551 is arranged to cover more than a half of the opening portion that is circular in plan view on the side closer to vehicle 10, for example.

Since part of the light emitted by light source 220 is absorbed, reflected, or diffused by light-shielding component 550 (more specifically, light shield 551), the light emitted by light source 220 is less likely to travel toward vehicle 10. Therefore, the amount of the light emitted by light emitter 510 that travels toward vehicle 10 is smaller than the amount of the light emitted by light emitter 510 that travels toward the opposite side to vehicle 10.

In plan view, light shield 551 may or may not cover light source 220.

For example, in plan view of principal surface 541 of substrate 540, light shield 551 is continuously arranged between a position corresponding to light source 220 and a position between light source 220 and vehicle 10. That is, light shield 551 continuously covers a range between a point below light source 220 that corresponds to light source 220 in plan view of principal surface 541 of substrate 540 and a point lateral to light source 220.

Flat plate 552 is a flat plate part mounted on principal surface 541 of substrate 540 between lens 530 and principal surface 541. Light shield 551 and flat plate 552 are integrally provided.

The material used for light-shielding component 550 is not particularly limited, and any material that absorbs, reflects, or diffuses at least part of the light emitted by light source 220 can be used.

For example, light-shielding component 550 is made of a metal material or the like that is reflective to the light emitted by light source 220. Alternatively, light-shielding component 550 may be made of a resin material or the like that contains a light diffusing agent, such as silica particles or titanium particles, that diffuses (or refracts) the light emitted by light source 220. Alternatively, light-shielding component 550 may be made of a resin material or the like that contains a light absorbing agent, such as a dye, that absorbs the light emitted by light source 220.

Specifically, for example, light-shielding component 550 may be made of polycarbonate (PC). In other words, light-shielding component 550 may be made of a material containing polycarbonate, for example. Alternatively, for example, light-shielding component 550 may be made of polypropylene (PP), polyphenylene sulfide (PPS), or polymethyl methacrylate (PMMA) or so-called acrylic.

Light shield 551 and flat plate 552 may be made of the same material or different materials. When light shield 551 and flat plate 552 are made of different materials, only light shield 551 needs to have a configuration capable of absorbing, reflecting, or diffusing the light emitted by light source 220, and flat plate 552 can have an arbitrarily configuration. The configuration capable of absorbing, reflecting, or diffusing light can be a configuration capable of absorbing part of light and reflecting the other part of the light, a configuration capable of absorbing part of light and diffusing the other part of the light, or any combination of configurations capable of absorbing, reflecting, or diffusing light. That is, light-shielding component 550 can have any configuration capable of at least one of absorption, reflection, and diffusion.

The thicknesses of light shield 551 and flat plate 552 are not particularly limited. For example, the thickness of flat plate 552 (for example, the thickness of the thinnest part thereof) is about 1 mm.

Light-shielding component 550 has only to be able to absorb, reflect, or diffuse at least part of light. For example, light-shielding component 550 has only to be able to absorb, reflect, or diffuse at least 70% of light. Alternatively, light-shielding component 550 may absorb, reflect, or diffuse at least 90% of light, for example. Specifically, for example, light-shielding component 550 may reflect at least 70% of the light emitted by light source 220. For example, light-shielding component 550 may reflect at least 80% of the light emitted by light source 220. For example, light-shielding component 550 may reflect at least 90% of the light emitted by light source 220.

For example, light-shielding component 550 may transmit at most 20% of the light emitted by light source 220. For example, light-shielding component 550 may transmit at most 5% of the light emitted by light source 220. For example, light-shielding component 550 may transmit at most 1% of the light emitted by light source 220.

The transmittance of 20%, 5% or the like referred to herein means a light transmittance in a case where the thickness of light-shielding component 550 is 2 mm, for example.

The color of light-shielding component 550 is not particularly limited and may be black, white, or other colors. However, the color of light-shielding component 550 is preferably white. In that case, light-shielding component 550 is less likely to generate heat from light.

Light-shielding component 550 may have a recessed portion (a gradual change portion) that is formed on a surface thereof and extends to the outer edge in plan view. Light-shielding component 550 (the flat plate 552, for example) may also have a portion (a gradual change portion) that decreases in thickness as it goes from the central part to the outer edge part in plan view. This has effects of increasing the surface rigidity, improving the vibration resistance, and reducing a deformation such as warpage due to shrinkage or the like. Lens 530 may have a recessed portion formed on a surface faring the recessed portion of light-shielding component 550.

A beam (a so-called rib) may be formed on light-shielding component 550. Specifically, flat plate 552 may have a beam formed along the edge part thereof on the vehicle 10 side. The beam reduces the occurrence of noise in light emitter 510.

Both the gradual change portions described above and the beam described above may be formed on flat plate 552. In that case, the occurrence of noise in light emitter 510 is further reduced.

As illustrated in FIG. 8, light-shielding component 550 (more specifically, flat plate 552) has through-hole 560 formed to penetrate light-shielding component 550 in the normal direction to the principal surface of flat plate 552 (the Z-axis direction in this embodiment). Substrate 540 also has through-hole 561 formed to penetrate substrate 540 in the normal direction to principal surface 541 (the Z-axis direction in this embodiment). Heat radiation sheet 516 also has through-hole 562 formed to penetrate heat radiation sheet 516 in the normal direction to the principal surface of heat radiation sheet 516 (the Z-axis direction in this embodiment). Heat sink 515 also has through-hole 563 formed to penetrate heat sink 515 in the normal direction to the principal surface of heat sink 515 (the Z-axis direction in this embodiment).

These through-holes 560 to 563 are arranged to coincide with each other in bottom view. Engagement unit 570 provided on lens 530 is inserted and arranged in these through-holes 560 to 563.

Engagement unit 570 is a columnar portion provided on lens 530. The arrangement of through-holes 560 to 563 and engagement unit 570 inserted therein facilitates alignment of heat sink 515, heat radiation sheet 516, substrate 540, light-shielding component 550, and lens 530.

After engagement unit 570 is inserted and arranged in through-holes 560 to 563 (that is, after each component is positioned), engagement unit 570 is processed (deformed) by heat caulking or the like so that engagement unit 570 does not drop off through-holes 560 to 563.

Although heat sink 515, heat radiation sheet 516, substrate 540, and light-shielding component 550 each have two through-holes 560, 561, 562, and 563, respectively, one through-hole or three or more through-holes may be formed in each of these components. Lens 530 can have a number of engagement units 570 corresponding to the number of through-holes 560 to 563.

The arrangement of through-holes 560 to 563 is not particularly limited and can be arbitrary. For example, light-shielding component 550 may have two through-holes 560 formed on the opposite sides of the opening portion of light-shielding component 550 (for example, at diagonal positions) in plan view.

Heat sink 515, heat radiation sheet 516, substrate 540, and light-shielding component 550 may further has a through-hole (a respiration hole), which is different from through-holes 560 to 563, in such a manner that the through-holes are in communication with each other. In that case, air can flow in and out of the region defined by lens 530 and substrate 540 through the respiration hole, so that heat can be prevented from being accumulated in the region. Heat sink 515, heat radiation sheet 516, substrate 540, and light-shielding component 550 may each have two respiration holes, for example. In that case, one respiration hole is subjected to a positive pressure, and the other respiration hole is subjected to a negative pressure, that is, the two respiration holes serve as an air inlet and an air outlet of the region, so that heat can be further prevented from being accumulated in the region.

The respiration hole may be provided with a seal (a so-called waterproof sheet) that is permeable to air but impermeable to water.

On light-shielding component 550, a pin (a projection, for example) may be formed so that light-shielding component 550 can be positioned with respect to lens 530, for example. On lens 530, a recessed portion that is to be engaged with the projection may be formed.

With the configuration described above, light emitter 510 disposed on side mirror 30 does not have to be inclined as a whole to reduce light traveling toward vehicle 10, unlike light emitter 110 illustrated in FIG. 7.

Light emitter 510 disposed on side mirror 30 may be inclined as a whole like light emitter 110.

As in the variation described above, the configuration of the light emitter may be modified in an arbitrary manner so that the light emitters of light-emitting device 200 emit light in a direction away from vehicle body 20.

For example, lens 230 may have a light reducing portion that reduces at least part of the light to be emitted toward vehicle body 20 of the light that is emitted from light emitter 110 and is incident on lens 230. The expression “the vehicle body 20 side” means the side closer to vehicle body 20 of lens 230 equally divided into two parts by a line segment parallel to the longitudinal direction (the direction parallel to the X axis in this embodiment) of vehicle 10 in top view of lens 230, for example. Alternatively, the light reducing portion may be formed in a part of lens 230 closer to vehicle body 20 in front view of vehicle 10. In that case, the light reducing portion can reduce the light traveling toward vehicle body 20 of the light emitted by light source 220. The light reducing portion is a part of lens 230 that reduces light, for example. For example, the light reducing portion may be formed on lens 230 by emboss processing, vapor deposition, two-color molding, insert molding, or laser illumination.

For example, the light emitter may be disposed in such a manner that the normal direction of substrate 240 is oblique to the vertical direction.

For example, a recessed portion may be formed on lens 230 of light source 220 so that the optical axis of the light emitted by light source 220 is inclined.

For example, the light emitter may be disposed in such a manner that the normal direction of a mounting substrate on which the solid-state light-emitting element of light source 220 is mounted is oblique to the vertical direction.

The variations described above may be light emitter 110, 120, 130, or 510.

### SUMMARY

As described above, light source unit 100 according to an embodiment includes light-emitting device 200 to be attached to vehicle 10 together with image capturing device 140, and light-emitting device 200 emits near infrared light to a road in a lateral area of vehicle 10 and a road in at least one of the front area or the rear area of vehicle 10.

Accordingly, light-emitting device 200 can emit near infrared light to a road (non-irradiated area 400, for example) around vehicle 10 that is not irradiated with the light emitted by side marker lamp 40, backup lamp 50 and the like of vehicle 10. Therefore, if image capturing device 140 attached to vehicle 10 is capable of detecting near infrared light, for example, image capturing device 140 can capture a precise image of the road.

For example, light-emitting device 200 emits near infrared light that illuminates the road at an illuminance of at least 1.0×10⁻³ W/m².

Accordingly, image capturing device 140 can capture a precise image of a road marking, such as a white line of a driving lane.

For example, light-emitting device 200 emits near infrared light that illuminates the road at an illuminance of at most 0.5 W/m².

Accordingly, the occurrence of a halation in image capturing device 140 can be prevented.

For example, light source unit 100 includes image capturing device 140 that detects the near infrared light emitted from light-emitting device 200 and reflected off the road, and control device 150 that controls light-emitting device 200 and image capturing device 140, and control device 150 causes the timing of emitting near infrared light by light-emitting device 200 to be same as the timing of capturing an image by image capturing device 140.

Accordingly, light-emitting device 200 can be prevented from unnecessarily emitting light.

For example, light-emitting device 200 (light emitter 510 of light-emitting device 200, for example) includes light source 220 and lens 530 that controls the distribution of light emitted from light source 220, and lens 530 includes recessed portion 534 located on the vehicle 10 side of outer surface 532 when viewed from light source 220 of lens 530, when lens 530 is attached to vehicle 10, where recessed portion 534 is recessed toward the light source 220, and outer surface 532 is opposite to inner surface 531 located closer to light source 220.

Accordingly, provided that the curvature, the depth and the like of recessed portion 534 are appropriately set, the light emitted from light source 220 toward recessed portion 534 can be reflected off lens 530 in a direction opposite to vehicle 10. Therefore, the light that is emitted from light emitter 510 and travels toward vehicle 10 is reduced. Therefore, the occurrence of a halation in image capturing device 140 due to light reflection on vehicle 10 can be reduced.

For example, light-emitting device 200 (light emitter 510 of light-emitting device 200, for example) includes light source 220 and light-shielding component 550 that shields part of near infrared light emitted from light source 220, and when light-shielding component 550 is attached to vehicle 10, light-shielding component 550 is disposed from the vehicle 10 side of light source 220 to continuously extend beyond a point directly below light source 220 when viewed from light source 220.

Accordingly, the light emitted from light source 220 toward light-shielding component 550 is less likely to exit lens 530 in the direction toward vehicle 10 because of light-shielding component 550. Therefore, the light emitted from light emitter 510 toward vehicle 10 is reduced. Therefore, the occurrence of a halation in image capturing device 140 caused by light reflection on vehicle 10 can be reduced.

For example, light-emitting device 200 includes a first light-emitter (light emitter 110, for example) to be attached to side mirror 30 of vehicle 10, and a second light-emitter (light emitter 120 or 130, for example) to be attached to at least one of a front part or a rear part of vehicle body 20 of vehicle 10, the first light-emitter emits near infrared light to the road in the lateral area of vehicle 10, and the second light-emitter emits near infrared light to the road in at least one of the front area or the rear area of vehicle 10.

Accordingly, non-irradiated area 400 can be irradiated with light with a simple configuration.

For example, light source unit 100 further includes image capturing device 140 that detects the near infrared light emitted from light-emitting device 200 and reflected off the road, and the second light-emitter is attached to vehicle body 20 at a location more vertically downward than image capturing device 140.

Accordingly, the light emitted from the second light emitter can be prevented from directly illuminating image capturing device 140 without being reflected off the road. Therefore, the occurrence of a halation in image capturing device 140 can be prevented.

For example, the second light-emitter is attached to an overhang surface (overhang surface 21 and/or 22, for example) of vehicle body 20.

Accordingly, the second light emitter can be easily disposed on vehicle body 20 in such a manner that the second light emitter emits no light at least above the horizontal direction.

For example, vehicle 10 according to an embodiment includes light source unit 100.

Accordingly, image capturing device 140 attached to vehicle 10 can capture a precise image of a road.

### OTHER EMBODIMENTS

Although a light-emitting device according to an embodiment and the like have been described above, the present invention is not limited to the embodiment described above.

For example, although the LED has been described as an example of the solid-state light-emitting element of light source 220 in the above embodiment, a semiconductor light-emitting element such as a semiconductor laser or a solid-state light-emitting element such as an organic electroluminescence (EL) element or inorganic EL element may be used.

For example, light source 220 may be implemented as an LED module having a surface mount device (SMD) structure or an LED module having the so-called chip-on-board (COB) structure having a substrate on which an LED chip is directly mounted.

The thickness of the lens is not particularly limited, as far as the thickness of the thinnest part is at least 0.5 mm. With this thickness, the moldability of the lens is improved.

For example, the light emitter may be disposed in such a manner that the direction of light emission from the light emitter is parallel to the Z-axis direction or the optical axis is arbitrarily inclined with respect to the Z-axis direction. For example, the light emitter may be disposed in such a manner that the optical axis is inclined toward the opposite side to the vehicle body at about 10° to 20° with respect to the vertical direction.

The number of light emitters of light-emitting device 200 is not particularly limited. For example, light-emitting device 200 may be implemented by one light emitter, as far as light-emitting device 200 can illuminate the road in the areas described above. The one light emitter may be attached to side mirror 30 or vehicle body 20, for example.

The positions of the light emitters on vehicle 10 are not particularly limited. All the light emitters may be disposed on vehicle body 20 or on side mirrors 30.

Image capturing device 240 need not be attached to side mirror 30 and may be attached to vehicle body 20.

Light source unit 100 may include one image capturing device or a plurality of image capturing devices. For example, as with light emitter 110 and image capturing device 140 attached to side mirror 30, an image capturing device may be further attached near each of light emitters 120 and 130.

For example, each component of the processor of control device 150 may be implemented by hardware such as a dedicated circuit or may be implemented by executing a software program for the component. Each component may be implemented by a program executor such as a central processing unit (CPU) or a processor reading and executing a software program stored in a non-temporary recording medium such as a hard disk or a semiconductor memory.

Other embodiments obtained by making various modifications that occur to those skilled in the art to each embodiment or embodiments obtained by combining components or functions in each embodiment in an arbitrary manner without departing from the spirit of the present invention are also included in the present invention.

For example, the light emitter of the light-emitting device need not have the structure of light emitter 110 illustrated in FIG. 7 and may have the structure of light emitter 510 illustrated in FIG. 8. When the light-emitting device includes a plurality of light emitters, the light-emitting device may include one or more light emitters having the structure of light emitter 110 and one or more light emitters having the structure of light emitter 510.

For example, it is possible that light emitter 510 has recessed portion 534 in lens 530 but does not have light-shielding component 550. Alternatively, it is also possible that light emitter 510 has light-shielding component 550 but does not have recessed portion 534 in lens 530.

### REFERENCE SIGNS LIST

10 vehicle
20 vehicle body
21, 22 overhang surface
30 side mirror
100 light source unit
110, 120, 130, 510 light emitter
140 image capturing device
150 control device
200 light-emitting device
220 light source
230, 530 lens
231, 531 inner surface
232, 532 outer surface
534 recessed portion
550 light-shielding component

1. A light source unit comprising:
a light-emitting device to be attached to a vehicle together with an image capturing device, wherein
the light-emitting device emits near infrared light to (i) a road in a lateral area of the vehicle and (ii) a road in at least one of a front area or a rear area of the vehicle.

2. The light source unit according to claim 1, wherein
the light-emitting device emits near infrared light that illuminates the road at an illuminance of at least 1.0×1.0⁻³ W/m².

3. The light source unit according to claim 1, wherein
the light-emitting device emits near infrared light that illuminates the road at an illuminance of at most 0.5 W/m².

4. The light source unit according to claim 1 further comprising:
the image capturing device that detects the near infrared light emitted from the light-emitting device and reflected off the road; and
a control device that controls the light-emitting device and the image capturing device, wherein
the control device causes a timing of emitting near infrared light by the light-emitting device to be same as a timing of capturing an image by the image capturing device.

5. The light source unit according to claim 1, wherein
the light-emitting device includes a light source and a lens that controls distribution of light emitted from the light source, wherein
the lens includes a recessed portion located on a vehicle side of an outer surface of the lens when viewed from the light source, when the lens is attached to the vehicle, the recessed portion being recessed toward the light source, the outer surface being opposite to an inner surface located closer to the light source.

6. The light source unit according to claim 1, wherein
the light-emitting device includes a light source and a light-shielding component that shields part of near infrared light emitted from the light source, and
when the light-shielding component is attached to the vehicle, the light-shielding component is disposed from a vehicle side of the light source to continuously extend beyond a point directly below the light source when viewed from the light source.

7. The light source unit according to claim 1, wherein
the light-emitting device includes:
a first light-emitter to be attached to a side mirror of the vehicle; and
a second light-emitter to be attached to at least one of a front part or a rear part of a vehicle body of the vehicle, wherein
the first light-emitter emits near infrared light to the road in the lateral area of the vehicle, and
the second light-emitter emits near infrared light to the road in at least one of the front area or the rear area of the vehicle.

8. The light source unit according to claim 7 further comprising:
the image capturing device that detects the near infrared light emitted from the light-emitting device and reflected off the road, wherein
the second light-emitter is attached to the vehicle body at a location more vertically downward than the image capturing device.

9. The light source unit according to claim 7, wherein
the second light-emitter is attached to an overhang surface of the vehicle body.

10. A vehicle comprising the light source unit according to claim 1.
